(19) United States
(12) Patent Application Publication
(10) Pub. No.: US 2003/0004854 A1
(43) Pub. Date: Jan. 2, 2003

(54) RFP decomposition and collaboration

(75) Inventors: David Perry Greene, Ossining, NY (US); Edith Helen Stern, Yorktown Heights, NY (US); Barry Edward Willner, Briarcliff Manor, NY (US); Philip Shi-Lung Yu, Chappaqua, NY (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/893,077

(22) Filed: Jun. 27, 2001

(51) Int. Cl. G06F 17/60

(52) U.S. Cl. 705/37

(57) ABSTRACT

A method, program and system for facilitating a request for proposal (RFP) in an electronic marketplace are provided. The method comprises posting the content of the RFP in an electronic marketplace. A portion of the RFP is sent to at least one of a plurality of primary and secondary marketplace participants (i.e. general contractors and subcontractors). In one embodiment, primary and secondary participants can directly access the RFP posted in the electronic marketplace. The primary and secondary participants can then attach their proposals directly to the RFP so that other marketplace participants may examine the proposals. In another embodiment, access to the posted proposals might be restricted to specific parties, rather than all marketplace participants.

### BACKGROUND OF THE INVENTION

1. Technical Field

The present invention relates generally to computer network environments and more specifically to the use of computer networks to facilitate requests for contract proposals.

2. Description of Related Art

Today, electronic marketplaces include the ability to post electronic Requests for Proposal (RFP). A RFP is a document that invites a vendor to submit a bid for goods and services. It may provide a general or very detailed information. RFPs are part of standard practice in contracting projects. A customer will submit a RFP for a particular subcontract and receive bids from potential contractors. These contractors may in turn contact subcontractors concerning parts of the contract. The use of electronic marketplaces can help facilitate this process by increasing ease and speed of communication between contractors and suppliers, as well as expand the range of potential contractors and suppliers.

However, current methods for employing RFPs do not allow non-prime contacts to respond to RFPs. For example, if a customer posts a RFP, only the general contractors who receive the RFP will be able to respond directly to the customer. If the contractors contact subcontractors, these subcontractors are not able to respond directly to the general contractor. If contract bids are chosen according to price, this lack of bottom-up communication might not be a significant problem. However, if quality matching optimization is a significant factor, the lack of bottom-up communication can create problems. For example, decisions at lower levels concerning types of material used might affect quality control issues and optimization with regard to parallel subcontracts. In such a situation, the customer might use this specific feedback to make changes in another RFP related to the same overall project.

Therefore, it would be desirable to have a method which enables decomposition and wider collaboration concerning RFPs.

### SUMMARY OF THE INVENTION

The present invention provides a method, program and system for facilitating a request for proposal (RFP) in an electronic marketplace. The method comprises posting the content of the RFP in an electronic marketplace. A portion of the RFP is sent to at least one of a plurality of primary and secondary marketplace participants (i.e. general contractors and subcontractors). In one embodiment, primary and secondary participants can directly access the RFP posted in the electronic marketplace. The primary and secondary participants can then attach their proposals directly to the RFP so that other marketplace participants may examine the proposals. In another embodiment, access to the posted proposals might be restricted to specific parties, rather than all marketplace participants.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4 depicts a diagram illustrating the relationship between a RFP and potential contractors in accordance with the present invention;

FIG. 5 depicts a diagram illustrating direct subcontractor attachment to a RFP is depicted in accordance with the present invention;

FIG. 6 depicts a diagram illustrating the application of security measures to a RFP in accordance with the present invention; and

FIG. 7 depicts a flowchart illustrating a general overview of RFP collaboration is depicted in accordance with the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

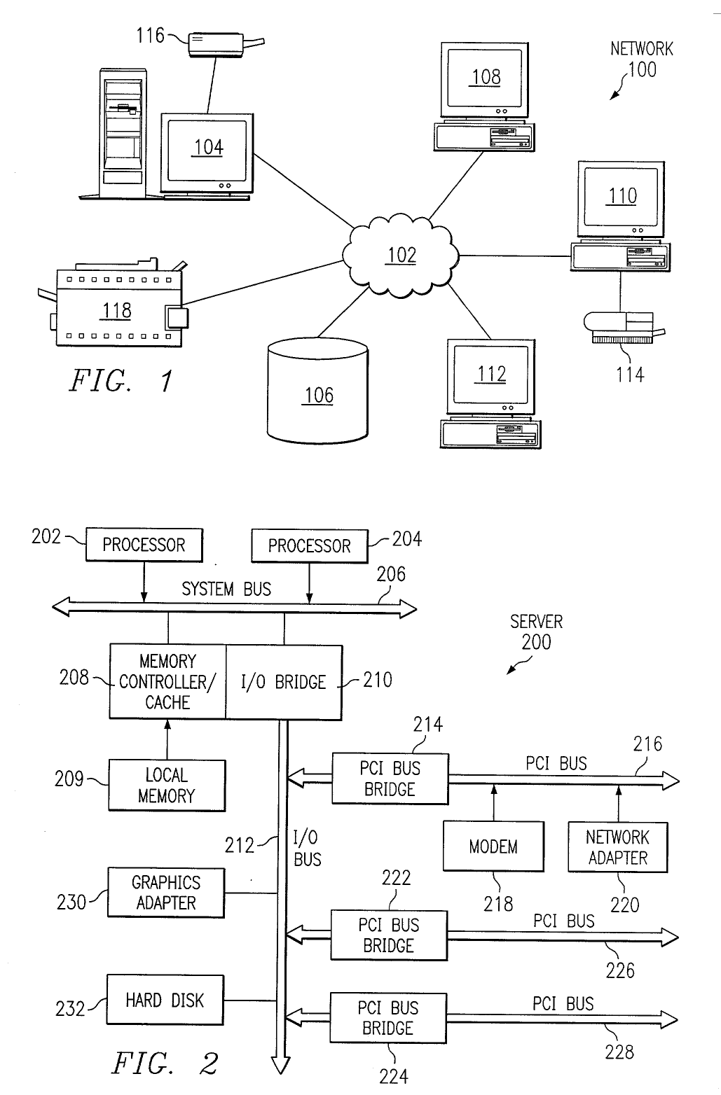

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly. Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

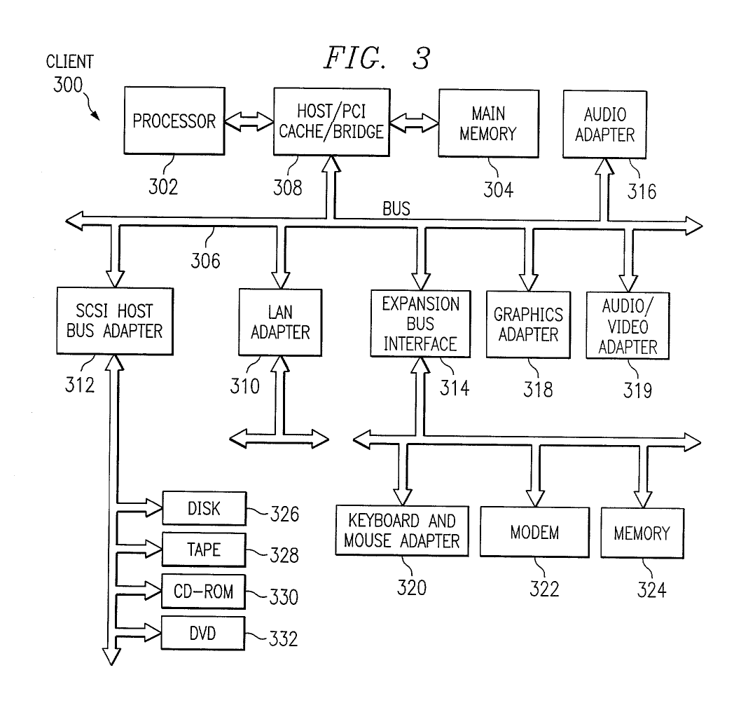

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, CD-ROM drive 330, and DVD drive 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3.

Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide nonvolatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention allows a party which is not a prime recipient of an electronic RFP to respond to a RFP. This, in turn, allows the issuer of the RFP, as well as other members of the electronic marketplace, to evaluate these potential contributions and publicly post their opinions. For the purposes of the present invention, a RFP is a document that invites a vendor to submit a bid for goods and services. It may provide a general or very detailed information. For example, a RFP may contain customer information, proposed terms of a contract, qualitative or quantitative specifications, as well as additional details, depending on the needs of the customer. A RFP may also be very simple and simply identify the customer and the type of good or service sought. RFPs are well known in the art and may vary considerably in form and content, according to customer needs and the nature of the good and services in question.

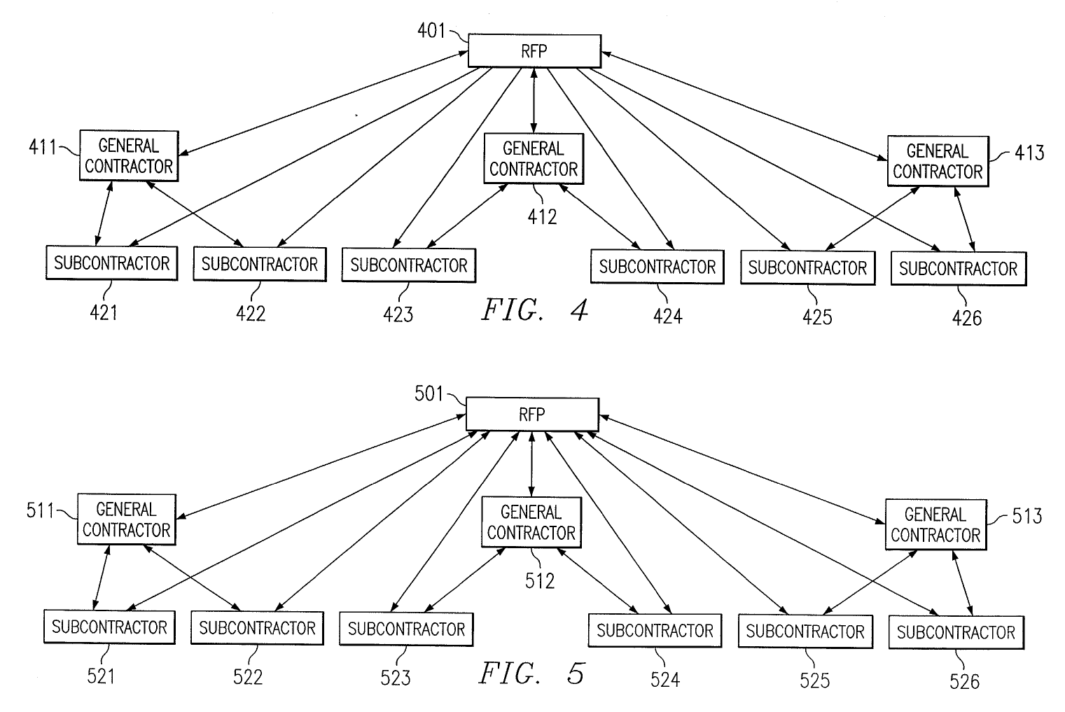

Referring to FIG. 4, a diagram illustrating the relationship between a RFP and potential contractors is depicted in accordance with the present invention. A customer seeking particular goods and services will post a RFP 401 in an electronic marketplace. In addition to making a general posting in the electronic market place, a copy of RFP 401 may be directly sent to general contractors (primary marketplace participants) 411-413. The general contractors 411-413 can respond directly to the customer by attaching their proposals and bids to RFP 401. The general contractors 411-413 may then contact potential subcontractors (secondary marketplace participants) 421-426 and convey particular components of RFP 401 related to a given subcontractor's specialty. A subcontractor, for example 421, may then respond in regard to its respective area of expertise. In addition to receiving partial RFP information from a general contractor, a subcontractor may also access a complete RFP that has been generally posted in an electronic marketplace. By understanding the other components and requirements of a RFP, a potential subcontractor may modify its proposal in order to optimize quality matching, rather than simply minimize total price.

Taking an example from FIG. 4, a corporate customer is moving into a new office and wants to set up its computer network and telecommunications system. Primary contact 411 receives a copy of RFP 401 describing the customer's requirements. The part of RFP 401 related to computer hardware and software requirement is sent to subcontractor 421. Rather than simply trying to submit the lowest bid for the computer network, subcontractor 421 might access RFP 401 and learn more about the customer's telecommunications requirements. As a result, subcontractor 421 might alter its proposal in order to optimize the compatibility of the computer and telecommunications resources.

In addition, the computer network might potentially be reconfigured in light of telecommunications requirements in order to reduce the customer's overall costs and resource requirements. This type of “big picture” feedback from subcontractors can produce a multilevel “ripple” effect from the bottom up. Based on an understanding of the overall project, a subcontractor can optimize its proposal, a higher level party takes this proposal and combines it with others and posts a major component of the RFP, and then a prime RFP contact picks up this component and uses it when bidding on the RFP. This process will allow a general contractor to better optimize the overall quality and costs of its proposal to the customer, both in the long and short term.

Though the example illustrated in FIG. 4 only shows two tiers of contractors, there may in fact be several more tiers of subcontractors using the method of the present invention.

Referring now to FIG. 5, a diagram illustrating a variation of the present invention allowing direct subcontractor attachment to a RFP is depicted in accordance with the present invention. In general, the relationship between the parties in FIG. 5 is substantially the same as in FIG. 4. As in FIG. 4, subcontractors 521-526 can submit their proposals to the general contractors 511-513. In addition, potential subcontractors may also attach their proposals directly to RFP 501, thereby bypassing general contractors 511-513. This approach facilitates more direct feedback and communication between subcontractors and a customer posting a RFP.

The configuration in FIG. 5 also allows a greater degree of lateral communication between contractors and subcontractors than the configuration illustrated in FIG. 4. For example, if subcontractor 522 attaches a proposal directly to RFP 501, general contractor 513 or subcontractor 525 might me able to factor in this previous proposal when making its own proposal. By contrast, using the configuration in FIG. 4, general contractor 413 or subcontractor 425 would only be indirectly aware of subcontractor 422's proposal through general contractor 411, who might filter out important information.

By enabling subcontractors to directly attach to a RFP, this approach enables the possibility of alternative work breakdowns, such that the subcontractors, as well as prime contacts, could propose different types of solutions to all or part of the RFP. In a sense, these breakdowns can spawn sub-RFPs. Based on feedback received directly from a subcontractor, the customer posting the RFP might modify certain specifications within the RFP of which the general contractors are not aware, or the customer might modify the specifications in another related RFP. The net effect of more direct bottom-up feedback is to provide better and lower cost proposals than would be available under a single breakdown.

However, some subcontractors may wish to restrict access to the proposals they attach to the RFP. This may be done for competitive reason, preventing rivals from imitating them. For example, a subcontractor specializing in flights control systems for aircraft may attach a proposal to an RFP, and then restrict access to the customer and specified general contractors by means of password which is sent to the designated parties. The subcontractor may also want to allow access to non-rival subcontractors. Continuing the example above, the flight control subcontractor might allow access by subcontractors who specialize in radar or communications systems.

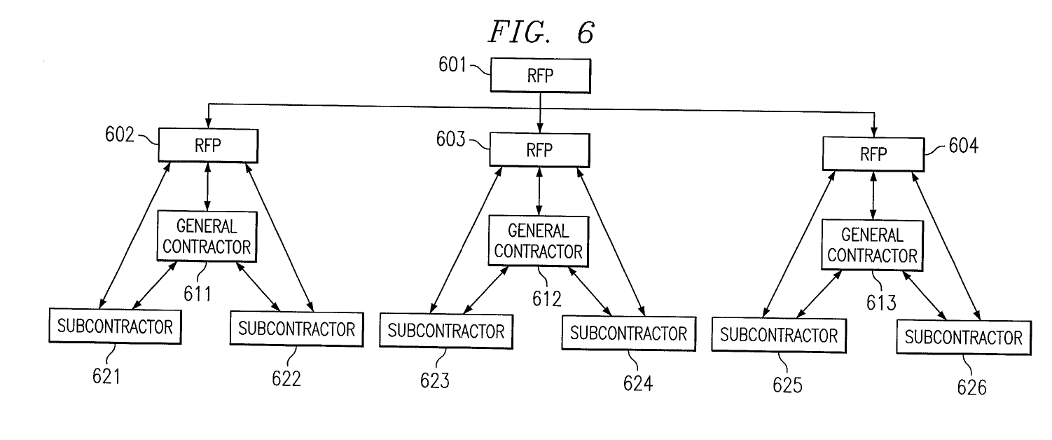

Referring to FIG. 6, a diagram illustrating the application of security measures to a RFP is depicted in accordance with the present invention. The communication configuration in FIG. 6 is similar to FIG. 5. However, in this case, RFP 601 has been broken into three sub-RFPs 602-604. This division of RFP 601 allows the customer to control the amount of the “big picture” which potential contractors and subcontractors can see. The classic case for such an application would be a government defense contract. The sub-RFP configuration offers a compromise between communication and security interests. The compromise in communication is primarily in relation to lateral communication and feedback between contractors. FIG. 6 still permits the vertical, bottom-up feedback feature of FIG. 5, but does not allow cross talk between parallel sub-RFP groups.

For example, subcontractors 621 and 622 can send their proposals to general contractor 611 or directly attach their proposals to RFP 602. Subcontractors 621 and 622 may also be able to access each other's proposals attached to RFP 602. However, contractors 611, 621 and 622 have no idea what contractors 612, 623 and 624 are proposing with regard to RFP 603. In fact, contractors 611, 621 and 622 most likely will have no idea that sub-RFPs 603 and 604 exist. Of course, it should be pointed out that FIG. 6 is merely an example. Simpler or more complex configurations are possible, depending on the number of contractor tiers and the degree of security desired by the client posting a RFP.

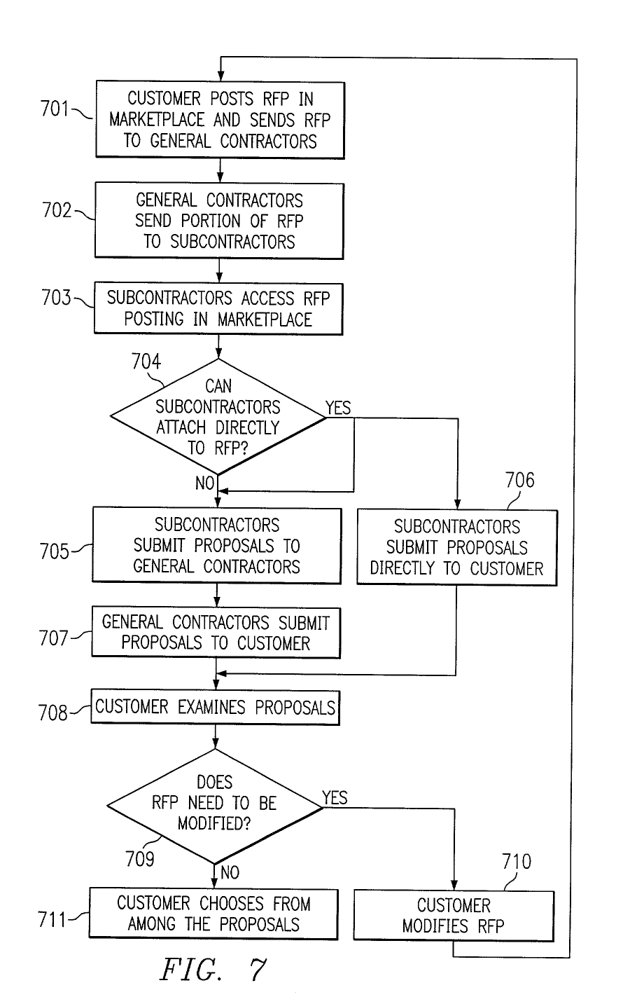

Referring now to FIG. 7, a flowchart illustrating a general overview of RFP collaboration is depicted in accordance with the present invention. This process flow accommodates the different RFP variations described above. As explained above, the process begins when a customer posts a RFP in an electronic marketplace and sends out the RFP to a designated group of general contractors (step 701). As explained in reference to FIG. 6, it is possible to break the RFP posting into pieces when posting for security purposes, so that each general contractor and subcontractor is only aware of a portion of the overall project. However, all subsequent steps are the same for a particular RFP posting, whether that posting is complete or partial.

The designated general contractors can then send a portion of the RFP (or the entire RFP) to specific subcontractors (step 702). Once they have been made aware of the RFP, the subcontractors can then access the original RFP posting in the electronic marketplace (step 703). The ability of the subcontractors to directly attach proposals to the original RFP posting is dependent upon the RFP model chosen (step 704).

If the subcontractors cannot attach proposals directly to the RFP posting, the subcontractors submit their proposals back to the general contractors from which they received their portion of the RFP (step 705). If the subcontractors can attach proposals directly to RFP postings, the subcontractors will still submit their proposals back to the general contractors (step 705), but will also be able to submit their proposals directly to the customer posting the RFP (step 706). The general contractors then submit their proposals (based on the respective subcontractor proposals) to the customer (step 707).

The customer examines the general contractors' proposals, as well as any subcontractor proposals that have been attached to the RFP posting (step 708). Based on the details of the proposals, the customer decides whether the RFP should be modified (step 709). As explained above, feedback from general contractors and subcontractors might provide details which require changes in the RFP in order to optimize factors such as price and/or quality control. If customer decides to modify the RFP, the customer enters the modifications (step 710) and reposts the RFP (step 701). If no changes to the RFP are deemed necessary, the customer chooses from among the proposals submitted by the general contractors (step 711).

Alternate configurations combining different elements of FIGS. 4, 5, and 6 are possible. In fact, the examples illustrated in FIGS. 4-6 are essentially basic building blocks from which more complex configurations may be constructed, according to the needs of a customer.

The present invention may be implemented in both public and private electronic marketplaces. A public marketplace has both multiple buyers and multiple sellers and may be used for open competitive bidding, merchandising, or similar functions. A private electronic marketplace has only one buyer or one seller. For example, a customer may post a RFP on its web site. However, in order to access this web site, a participant (general contractor or subcontractor) needs to use a password. In the context of the present invention, the customer posting the RFP will send the necessary password to specific general contractors, which will allow the contractors to access the private web site and view the posted RFP. The general contractors may then in turn send the password to specific subcontractors. alternatively, the customer may also send the password directly to subcontractors.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the depicted illustrations show the mechanism of the present invention embodied on a single server, this mechanism may be distributed through multiple data processing systems. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for facilitating a request for proposal (RFP) in an electronic marketplace, the method comprising the computer implemented steps of:
posting the RFP in an electronic marketplace;
communicating a portion of the RFP to at least one of a plurality of primary and secondary marketplace participants; and
posting a proposal in the electronic marketplace from at least one of the primary and secondary marketplace participants, wherein the proposal is associated with the RFP.

2. The method according to claim 1, further comprising:
facilitating direct access to the RFP by the primary and secondary marketplace participants.

3. The method according to claim 1, wherein access to the proposals posted by primary and secondary marketplace participants is restricted to specific parties.

4. The method according to claim 1, further comprising:
posting a modified version of the original RFP in the electronic market place, wherein modifications are based upon proposals submitted by the primary and secondary marketplace participants.

5. The method according to claim 1, wherein the electronic marketplace is a public marketplace.

6. The method according to claim 1, wherein the electronic marketplace is a private marketplace.

7. A computer program product in a computer readable medium for use in a data processing system, for facilitating a request for proposal (RFP) in an electronic marketplace, the computer program product comprising:
first instructions for posting the RFP in an electronic marketplace;
second instructions for communicating a portion of the RFP to at least one of a plurality of primary and secondary marketplace participants; and
third instructions for posting a proposal in the electronic marketplace from at least one of the primary and secondary marketplace participants, wherein the proposal is associated with the RFP.

8. The computer program product according to claim 7, further comprising:
instructions for facilitating direct access to the RFP by the primary and secondary marketplace participants.

9. The computer program product according to claim 7, wherein access to the proposals posted by primary and secondary marketplace participants is restricted to specific parties.

10. The computer program product according to claim 7, further comprising:
instructions for posting a modified version of the original RFP in the electronic market place, wherein modifications are based upon proposals submitted by the primary and secondary marketplace participants.

11. The computer program product according to claim 7, wherein the electronic marketplace is a public marketplace.

12. The computer program product according to claim 7, wherein the electronic marketplace is a private marketplace.

13. A system for facilitating a request for proposal (RFP) in an electronic marketplace, the method comprising the computer implemented steps of:
a posting component which posts the RFP in an electronic marketplace;
a first communicating component which communicates a portion of the RFP to at least one of a plurality of primary and secondary marketplace participants; and
posting a proposal in the electronic marketplace from at least one of the primary and secondary marketplace participants, wherein the proposal is associated with the RFP.

14. The system according to claim 13, further comprising:
an accessing component which facilitates direct access to the RFP by the primary and secondary marketplace participants.

15. The system according to claim 13, wherein access to the proposals posted by primary and secondary marketplace participants is restricted to specific parties.

16. The system according to claim 13, further comprising:
a posting component which posts a modified version of the original RFP in the electronic market place, wherein modifications are based upon proposals submitted by the primary and secondary marketplace participants.

17. The system according to claim 13, wherein the electronic marketplace is a public marketplace.

18. The system according to claim 13, wherein the electronic marketplace is a private marketplace.
